(19) United States
(12) Patent Application Publication
(10) Pub. No.: US 2017/0344131 A1
(43) Pub. Date: Nov. 30, 2017

(54) POINTER-BASED GUI FOR MOBILE DEVICES

(71) Applicant: International Business Machines Corporation, Armonk, NY (US)

(72) Inventors: Thomas H. Gnech, Herrenberg (DE); Regina Illner, Nufringen (DE); Joachim Rese, Hockenheim (DE)

(21) Appl. No.: 15/426,096

(22) Filed: Feb. 7, 2017

Related U.S. Application Data
(63) Continuation of application No. 15/168,534, filed on May 31, 2016.

(51) Int. Cl. G06F 3/0346

(52) U.S. Cl. CPC G06F 3/0346

(57) ABSTRACT

In an approach to pointer positioning, a computing device receives an instruction to enter a Move Mode. The computing device magnifies, in Move Mode, screen content to generate a virtual display. The computing device displays a first portion of the virtual display and a fixed pointer on the virtual display. The computing device receives physical movement data. The computing device analyzes the physical movement data. The computing device displays a second portion of the virtual display based on the analyzed physical movement data. The computing device receives an instruction to leave Move Mode. The computing device deactivates Move Mode.

### TECHNICAL FIELD OF THE INVENTION

The present disclosure relates generally to mobile device graphical user interfaces (GUIs), and more particularly to methods and systems for positioning a pointer (or “cursor”) of a mobile device GUI.

### BACKGROUND OF THE INVENTION

Conventional technology enables positioning of a cursor of a mobile device GUI based on contact with a touch screen. For example, a user may position the cursor over a display element of the GUI (e.g., a button) by touching the touch screen with a finger, a stylus, or another touch object and dragging the touch object across the touch screen.

### SUMMARY

According to an embodiment of the present invention, a computer-implemented method for a pointer-based GUI, the method comprising: receiving, by one or more computer processors, an instruction to enter a Move Mode; magnifying, by one or more computer processors, in Move Mode, screen content to generate a virtual display; displaying, by one or more computer processors, a first portion of the virtual display and a fixed pointer on the virtual display; receiving, by one or more computer processors, physical movement data; analyzing, by one or more computer processors, the physical movement data; displaying, by one or more computer processors, a second portion of the virtual display based on the analyzed physical movement data; receiving, by one or more computer processors, an instruction to leave Move Mode; and deactivating, by one or more computer processors, Move Mode to restore the screen content to an unmagnified size.

### BRIEF DESCRIPTION OF THE DRAWINGS

FIG. 1A-B shows a block diagram of an exemplary computing environment and components of a pointer-based GUI program, respectively, in accordance with an embodiment of the present invention;

FIG. 2 is a flowchart depicting operations of a pointer-based GUI method, in accordance with an embodiment of the present invention;

FIG. 3A-B shows exemplary screen views, in accordance with embodiments of present invention; and

FIG. 4 is a block diagram of components of the computing device in FIG. 1 executing a pointer-based GUI program, in accordance with an embodiment of the present invention.

### DETAILED DESCRIPTION

Embodiments described herein provide methods, computer program products, and/or computer systems that enable positioning of a pointer of a GUI of a device based on moving the device, rather than touching a surface of the device. Display elements remain visible while a centered pointer is positioned, by movement of the device, on a magnified element.

Embodiments of the present invention may recognize one or more of the following facts, potential problems and/or potential areas for improvement with respect to the current state of the art: (i) cursor positioning on a mobile device can be a painstaking and error-prone process; (ii) a touch display must be hit very accurately, but screen content may be very small, for example the width of a letter ‘l’ on a 5-inch touch screen with a standard font size is approximately 0.06 cm; and/or (iii) touch objects tend to cover the text underneath.

Embodiments of the present invention may include one or more of the following features, characteristics, and/or advantages: (i) the haptic experience is comparable to that of using a conventional mouse, where the pointer is the equivalent of a mouse pointer; (ii) more precise cursor positioning is enabled; (iii) an alternative or supplement to the touch screen standard is provided; (iv) the user experience may be superior (a) for applications that require accurate pointer positioning, (b) in the case of devices that are too small for a conventional touch screen interface (e.g., smart watches) due to the magnification of display elements and/or intuitive positioning movements, (c) in the case of applications that require movement of an object over a background (e.g., augmented reality applications), (d) for a user wearing gloves because of weather or working conditions, (e) for a user with a handicap such as lost fingers or limited vision, and/or (f) for a user with limited movement control (e.g., due to Parkinson's disease); and/or (v) easier porting of desktop applications to a mobile GUI, because a fixed visible screen layout is not required.

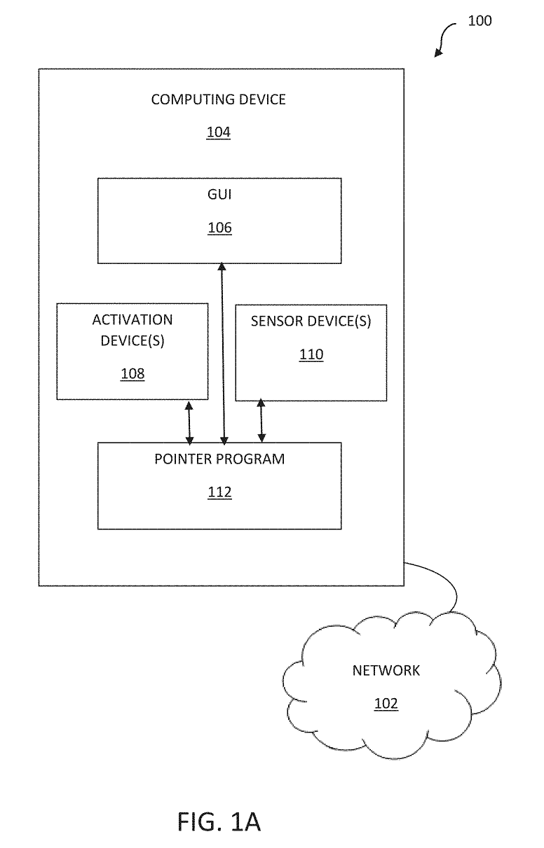

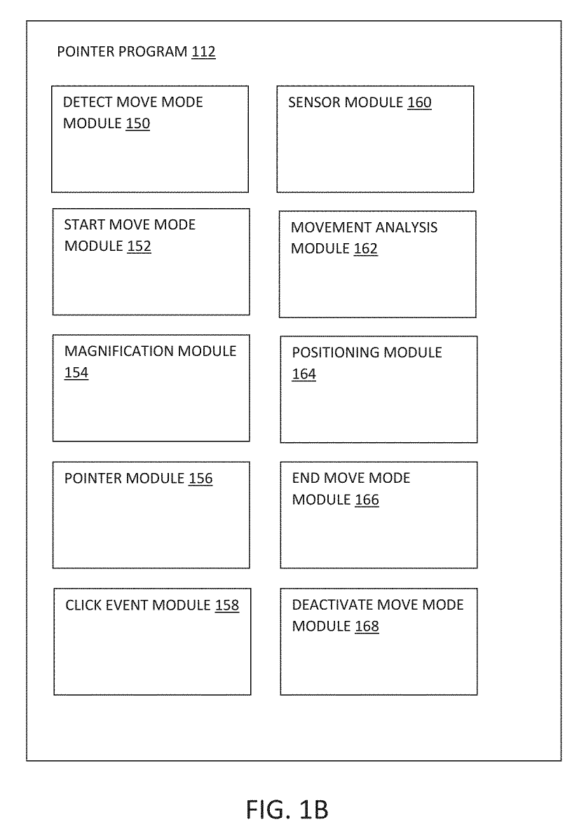

Embodiments of the present invention are described herein with reference to the Figures. FIG. 1A shows a block diagram of a computing environment 100, in accordance with an embodiment of the present invention. FIG. 1A is provided for the purposes of illustration and does not imply any limitations with regard to the environments in which different embodiments can be implemented. Many modifications to the depicted environment can be made by those skilled in the art without departing from the scope of the invention as recited in the claims.

Computing environment 100 includes computing device 104, which can be interconnected with other devices (not shown) over network 102. Network 102 can be, for example, a telecommunications network, a local area network (LAN), a wide area network (WAN), such as the Internet, or a combination of these, and can include wired, wireless, or fiber optic connections. In general, network 102 can be any combination of connections and protocols that will support communications between computing device 104 and other computing devices (not shown) within computing environment 100.

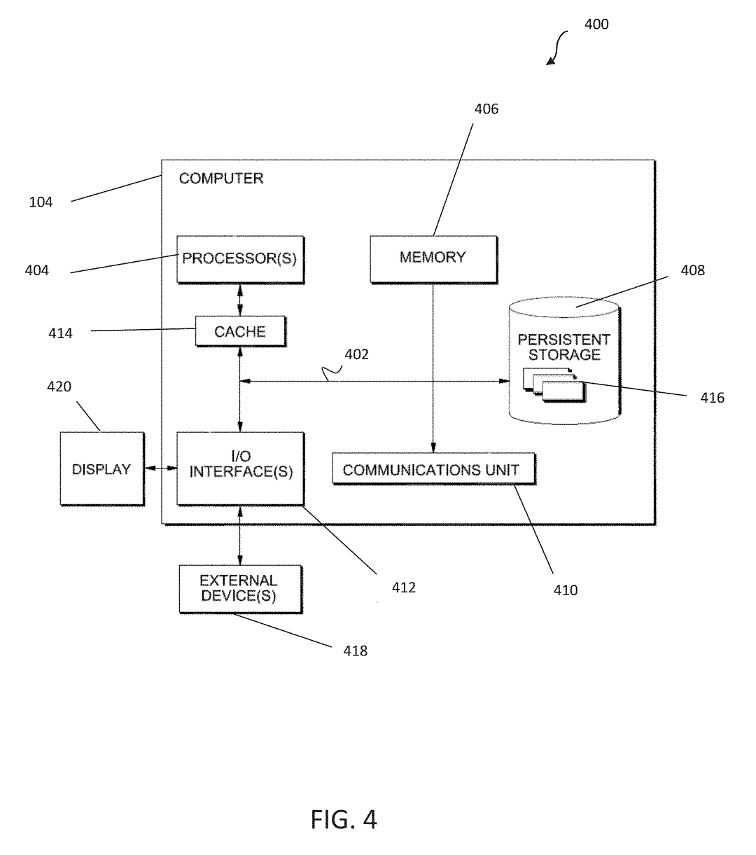

Computing device 104 can be any programmable electronic device capable of executing machine-readable instructions and communicating with other devices over network 102, in accordance with an embodiment of the present invention. Computing device 104 includes GUI 106, activation device(s) 108, sensor device(s) 110, and pointer program 112. Computing device 104 may include internal and external hardware components, as depicted and described in further detail with reference to FIG. 4.

GUI 106 provides an interface between a user of computing device 104 (not shown) and computing device 104.

Activation device(s) 108 may include, but are not limited to including, one or more hardware buttons, one or two-level (e.g., half push, whole push) software buttons, touch pressure sensors, a microphone for capturing voice commands, a camera, and other activation recognition means for entering a Move Mode (described herein).

Sensor device(s) 110 comprise one or more position or motion-aware hardware sensors such as but not limited to a gyroscope; accelerometer; and other gravity, orientation, and rotation sensors.

In a non-limiting example, sensor device(s) 110 may comprise an acceleration sensor that measures an acceleration applied to computing device 104, including the force of gravity. In the same example, an instance of a default acceleration sensor may be obtained using the following code:

private SensorManager mSensorManager;
private Sensor mSensor;
. . .
mSensorManager = (SensorManager) getSystemService
(Context.SENSOR_SERVICE);
mSensor = mSensorManager.getDefaultSensor
(Sensor.TYPE_ACCELEROMETER);

Pointer program 112 allows the user to enter a Move Mode, wherein the user can position a pointer on GUI 106 by moving computing device 104. The visual experience produced may be similar to that of aiming the fixed sight of a firearm at targets on a large virtual display.

Pointer program 112 may be implemented as, for example but without limitation, one or more of a modification to operating system software of computing device 104 (i.e., an addition of code to the operating system software); an addition of pointer program code in the form of a software plug-in; and built-in code in firmware. Although a modification to operating system software of computing device 104 may result in the best performance in terms of accuracy, smoothness of display change, and reusability, a plug-in-based implementation (i.e., using API calls) may be used if computing device 104 does not have necessary capabilities built in. Embodiments described herein use elements from an Android API for non-limiting, illustrative purposes.

Pointer program 112 may include, for example but without limitation, the Android sensor framework (not illustrated), part of the android.hardware package, to enable access to sensor device(s) 110. Within the sensor framework:
(1) The SensorManager class may provide methods for accessing and listing sensor device(s) 110, registering and unregistering sensor event listeners, and acquiring orientation information;
(2) The Sensor class may further create instances of specific sensor device(s) 110 to be used for further processing;
(3) The SensorEvent class may create a sensor event object, which provides, among other data, raw sensor data; and
(4) The SensorEventListener interface may receive notifications (sensor events) when sensor values change or when sensory accuracy changes.

FIG. 1B represents components of pointer program 112, in accordance with an embodiment of the present invention. Pointer-based positioning program 112 includes detect Move Mode module (“mod”) 150, start Move Mode module (“mod”) 152, magnification module (“mod”) 154, pointer module (“mod”) 156, click event module (“mod”) 158, sensor event module (“mod”) 160, movement analysis module (“mod”) 162, positioning module (“mod”) 164, end Move Mode module (“mod”) 166, and deactivate Move Mode module (“mod”) 168.

Mod 150 triggers Move Mode based on, for example but without limitation, detection of a predefined movement pattern by one or more sensor device(s) 110 or a user interaction with activation device(s) 108.

Mod 152 may, in a non-limiting example:
(1) Register, for required sensor device(s) 110, a SensorEventListener with SensorManager;
(2) Create sensor event objects for required sensor device(s) 110;
(3) Loop, until Move Mode is deactivated, to process sensor events, indicated by SensorEventListener, by obtaining sensor data from the sensor event objects.

Mod 154 magnifies screen content displayed by GUI 106, with the effect of creating a large, virtual display, wherein “virtual” is defined as extending beyond the portion visible at one time on the screen of computing device 104, and wherein the user may navigate the virtual display by moving computing device 104 from portion to portion. The screen content may be, e.g., that of an active application or a desktop. More precise pointer positioning may be effectuated by increased magnification.

Mod 156 displays a clipping (i.e., a portion of the virtual display) having a fixed pointer located at its center.

Mod 158 detects a click event, analogous to a conventional mouse click, and broadcasts the click event to be consumed by the application or desktop manager. [The PowerPoint states that double-click events may be implemented similarly to click-events. What is the usual distinction between double-click events and click events that should be emphasized?]

Mod 160 detects a move event from one or more sensor device(s) 110.

Mod 162 may, responsive to mod 160 detecting a move event, read associated sensor event objects to obtain and process the movement data. Mod 162 may consider acceleration and calculate a 3-D position of computing device 104. Mod 162 may further project the 3-D position to a 2-D position, or “display plane.” Mod 162 may correct for unintentional, minor movements, such as but without limitation vibrations not intended to affect pointer positioning. For example, mod 162 may apply a low-pass filter to correct for unintentional movements.

Mod 164 changes the position of the pointer based on the sensor data detected by mod 160 and processed by mod 162. For example, mod 164 causes the clipping of the magnified display to be adjusted, with the pointer remaining fixed at the center.

Mod 166 may, in a non-limiting example, unregister SensorEventListener with SensorManager to end looped processing of sensor events.

Mod 168 deactivates Move Mode.

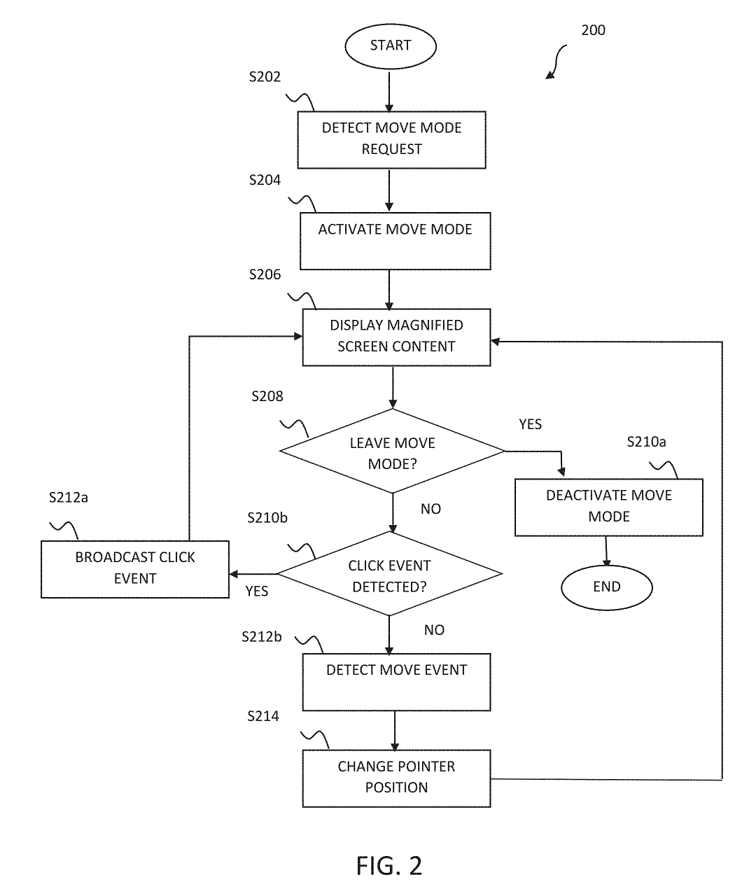

FIG. 2 is a flowchart 200 depicting operations of a pointer-based positioning method, in accordance with an embodiment of the present invention.

In operation S202, mod 150 detects a Move Mode request, such as but not limited to a button press.

In operation S204, mod 152 activates Move Mode.

In operation S204, mod 154 magnifies screen content displayed at the time of Move Mode activation.

In operation S206, mod 156 displays a clipping of the magnified screen content and a fixed pointer located at the center of the display.

In operation S208, mod 166 may receive a user request to leave Move Mode. If mod 166 receives a user request to leave Move Mode (S208, ‘YES’), then in operation S210a, mod 168 deactivates Move Mode. If mod 166 does not receive a user request to leave Move Mode (S208, ‘NO’), processing proceeds to operation S210b.

In operation S210b, mod 158 may detect a click event.

If mod 158 detects a click event (S210b, ‘YES’), then in operation S212a, mod 158 may broadcast the click event to an active application or desktop manager. Processing continues from operation S206. If mod 158 does not detect a click event (S210b, ‘NO’), then processing proceeds to operation S212b.

In operation S212b, mod 160 detects a move event.

In operation 5214, mod 162 changes the position of the displayed pointer based on the move event detected by mod 160 in operation S212b. Processing continues from operation S206.

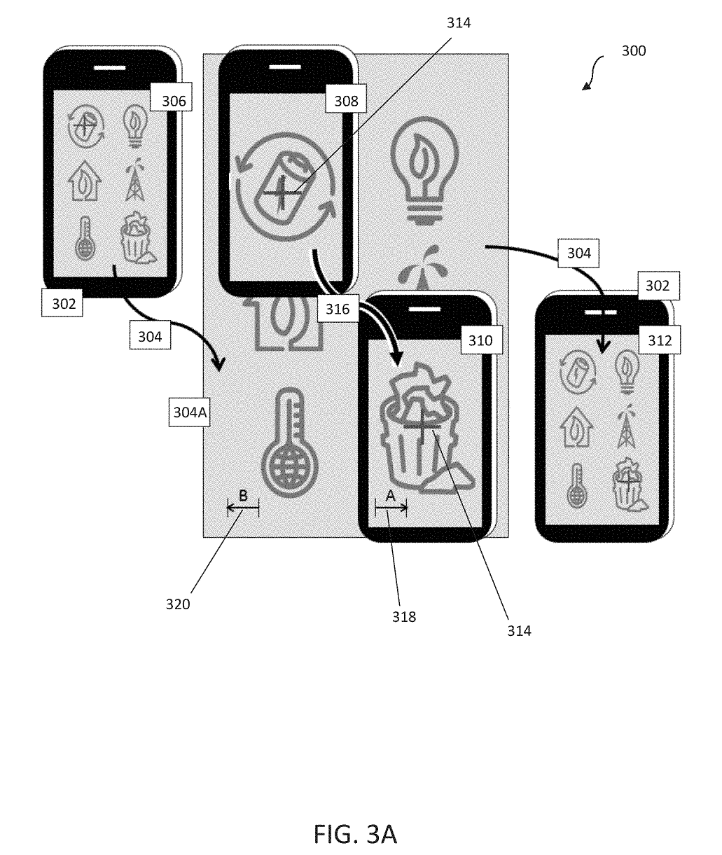

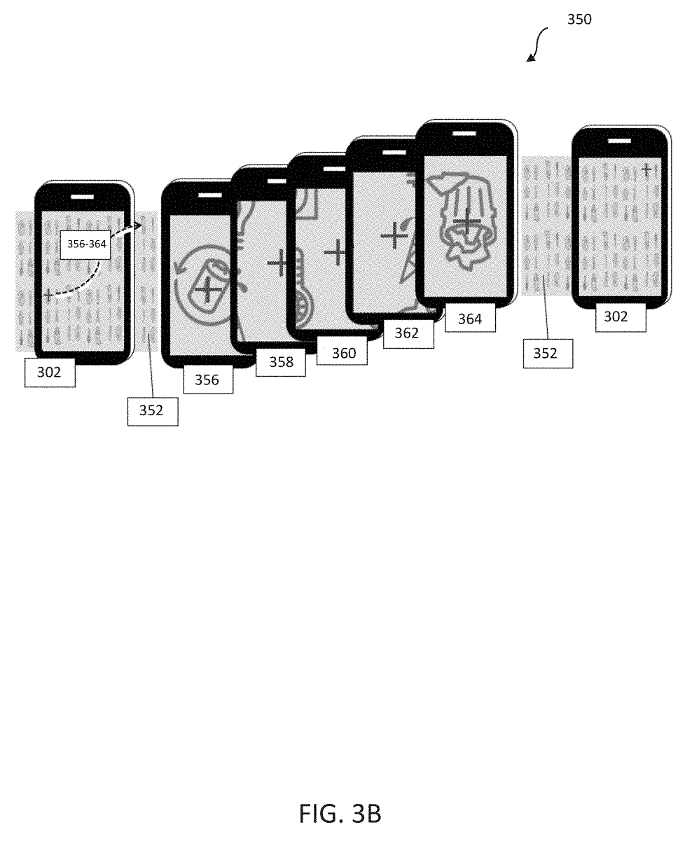

FIG. 3A shows illustration 300 of a pointer-based GUI program in use on a mobile device 302. Mobile device 302 may be similar in some or all respects to computing device 104; however, numbering in this example begins at 300 in the interest of clarity.

Screen content 304 may be, for example but without limitation, displayed by an application on mobile device 302. Screen shots 306-312 show a movement path of mobile device 302 between activation (306) and deactivation (312) of Move Mode.

Screen shot 306 shows all screen content ordinarily displayed by the application. Upon activation, pointer program 112 introduces a state in which pointer movements based on movement of computing device 104 are allowed. A pointer 314 may be displayed.

Screen shot 308 shows a magnified screen content 304A in Move Mode. Pointer 314 is fixed at the center of screen content 304A.

As computing device 302 moves along path 316, pointer program 112 keeps magnified screen content 304A stable based on the dimensions of the physical screen. For example, if computing device 302 moves 10 mm (distance ‘A’, 318) from left to right horizontally, the displayed portion of the virtual display appears to be moved on the physical screen by a factor of f*10 mm (distance ‘B’, 320) from right to left horizontally, where factor ‘f’ determines the ratio of physical device movement (distance 318) compared to the apparent movement of the virtual display (distance 320). Factor ‘f’ is preferably set to a value of 1 to achieve the effect of a fixed-position virtual display. A similar distance calculation principle may apply to vertical movement and the resulting vector of horizontal and vertical movement, in order to enable movement along a curved path 322.

Screen shot 312 shows screen content 304 upon deactivation of Move Mode. Pointer 314 appears at its new location.

FIG. 3B shows illustration 350 of a pointer-based GUI program in use on an oversized desktop 352 displayed on mobile device 302. In this example, “oversized” is defined as not ordinarily being displayed in its entirety within the boundaries of physical screen 354. Screen shots 356-364 show a movement path of mobile device 302 in Move Mode.

FIG. 4 depicts a block diagram 400 of components of computing device 104 in computing environment 100, in accordance with illustrative embodiments of the present invention. It should be appreciated that FIG. 4 provides only an illustration of one implementation and does not imply any limitations with regard to the environments in which different embodiments may be implemented. Many modifications to the depicted environment may be made.

Computing device 104 includes communications fabric 402, which provides communications between computer processor(s) 404, memory 406, persistent storage 408, communications unit 410, and input/output (I/O) interface(s) 412, and cache 414. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) and cache memory 414. In general, memory 406 can include any suitable volatile or non-volatile computer readable storage media. Cache 414 is a fast memory that enhances the performance of computer processor(s) 404 by holding recently accessed data, and data near accessed data, from memory 406.

Program instructions and data used to practice embodiments of the invention, referred to collectively as component(s) 416, are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive can be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. Communications unit 410 can include one or more network interface cards. Communications unit 410 can provide communications through the use of either or both physical and wireless communications links. Component(s) 416 can be downloaded to persistent storage 408 through communications unit 410.

I/O interface(s) 412 allows for input and output of data with other devices that may be connected to computing device 104. For example, I/O interface 412 can provide a connection to external devices 418 such as a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention, e.g., component(s) 416, can be stored on such portable computer readable storage media and can be loaded onto persistent storage 408 via I/O interface(s) 412. I/O interface(s) 412 also connect to a display 420.

Display 420 provides a mechanism to display data to a user and may be, for example, a touch screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for a pointer-based GUI, the method comprising:
receiving, by one or more computer processors, an instruction to enter a Move Mode;
magnifying, by one or more computer processors, in Move Mode, screen content to generate a virtual display;
displaying, by one or more computer processors, a first portion of the virtual display and a fixed pointer on the virtual display;
receiving, by one or more computer processors, physical movement data;
analyzing, by one or more computer processors, the physical movement data;
displaying, by one or more computer processors, a second portion of the virtual display based on the analyzed physical movement data;
receiving, by one or more computer processors, an instruction to leave Move Mode; and
deactivating, by one or more computer processors, Move Mode to restore the screen content to an unmagnified size.

2. The computer-implemented method of claim 1, wherein the screen content is associated with an active application.

3. The computer-implemented method of claim 1, wherein the screen content is associated with a mobile desktop.

4. The computer-implemented method of claim 1, wherein the screen content is associated with an oversized desktop.

5. The computer-implemented method of claim 1, wherein the fixed pointer is positioned at the center of the virtual display.

6. The computer-implemented method of claim 1, wherein analyzing the physical movement data further comprises:
applying, by one or more computer processors, a low-pass filter to preclude selected movement data from affecting positioning of the pointer.

7. The computer-implemented method of claim 1, further comprising:
detecting, by one or more computer processors, a click event; and
broadcasting, by one or more computer processors, the click event for consumption by an application or a desktop manager.
